(19) United States
(12) Patent Application Publication
(10) Pub. No.: US 2013/0248499 A1
(43) Pub. Date: Sep. 26, 2013

(54) METHOD FOR JOINING TWO PARTNERS TO BE JOINED, I.E. CERAMIC AND METAL/CERAMIC MATERIALS, USING A LASER BEAM

(71) Applicants: Alexander Dohn, Memmelsdorf (DE); Kunibert Reiss, Pechbrunn (DE); Alfred Thimm, Wunsiedel (DE)

(72) Inventors: Alexander Dohn, Memmelsdorf (DE); Kunibert Reiss, Pechbrunn (DE); Alfred Thimm, Wunsiedel (DE)

(73) Assignee: CeramTec GmbH, Plochingen (DE)

(21) Appl. No.: 13/878,603

(22) PCT Filed: Oct. 12, 2011
(86) PCT No.: PCT/EP11/67781

§ 371 Date: May 31, 2013

(30) Foreign Application Priority Data
Oct. 13, 2010 (DE) 10 2010 048 193.9

(51) Int. Cl. B23K 26/32

(52) U.S. Cl. CPC B23K 26/32
USPC 219/121.64

(57) ABSTRACT

The invention relates to a method for joining two partners to be joined at defined joining points, one partner (1) being made of a ceramic material and the other partner being made of a metal or a ceramic material. The aim of the invention is to improve such a method in such a way as to make the same easy to use while creating a permanent joint. Said aim is achieved by arranging the partners (1) to be joined in such a way that the partners (1) are in contact with each other at the joining points, and directing a laser beam to one of the partners (1) at the joining points in such a way as to make the laser beam shoot through said partner and at least partially penetrate into the other partner (1).

The invention relates to a method for joining two partners that are to be joined at their defined joining sites, one joining partner being made of a ceramic and the other joining partner being made of a metal or a ceramic.

The bonding of metals to ceramics by metallization is known from the state of the art in electronics, for example, from thin film to active solder to thick film to tungsten-centered metallization, all of which may be reinforced by galvanic metal deposition.

The object of the present invention is to improve upon a method according to the definition of the species, such that it will be simple to apply and nevertheless will create a long-lasting connection.

According to the invention, this object is achieved by the fact that the joining partners are arranged so that they come in contact with one another at the joining sites, and a laser beam is directed at one of joining partners at the joining sites, passing through this joining partner and penetrating at least partially into the other joining partner.

Depending on the atmosphere deflecting the laser beam, the result is the formation of smoke and/or a reaction product. This smoke usually condenses within the slot that has been formed, suddenly welding the two joining partners. The slot formed by the laser beam is thus filled with the reaction product, fixedly joining the two partners to one another.

The joining partner of ceramic is preferably made of aluminum nitride, AlNi, and the metal joining partner is preferably made of aluminum. The reaction product or the smoke is then comprised of aluminum, aluminum oxide and aluminum nitride.

This method may be used for bonding a ceramic to a metal, e.g., AlNi/aluminum, or bonding one ceramic to an identical ceramic or to some other type of ceramic.

In a preferred embodiment, the laser beam is aimed at the ceramic and not at the metal. Therefore the required laser need not be as strong. If the laser beam were to be aimed at the joining partner made of metal, the metal would dissipate the energy of the laser beam too rapidly, so the metal at the joining site would melt over a larger area.

Slots with a length of 1 mm to 5 mm, especially preferably of 3 mm, are advantageously formed by the laser beam. At these slot lengths, the separating power of the joining partners is sufficient. A length of 3 mm has proven to be especially expedient. In an experiment, a separating force of 50 N was achieved with a length of 3 mm.

To distribute the separating force over a larger area, a pattern of individual slots is preferably formed in the joining partners by the laser beam, so that all the slots form either longitudinal slots or transverse slots running perpendicular to the longitudinal slots.

To further improve the distribution of the slots, a transverse slot is preferably formed near each longitudinal slot. Longitudinal slots and transverse slots therefore alternate and the separating force is the same in each direction.

All the longitudinal slots are preferably located on parallel longitudinal rows at a fixed distance from one another in particular, and all the transverse slots are situated on parallel transverse rows at a fixed distance from one another, and a longitudinal slot is formed near each transverse slot. This yields a checkerboard pattern, in particular when the distance between the longitudinal rows and the transverse rows is the same.

Depending on the material used for the joining partners, the laser beam is preferably deflected onto the joining partner in an atmosphere (reactive gas) of stagnant air, flowing air or flowing nitrogen.

In a preferred embodiment, flat sheets are used for both joining partners. Flat sheets can easily be stacked on top of one another, thereby facilitating the joining.

In one embodiment, the joining partner made of metal is between 0.5 and 3.0 mm thick. At this thickness, the laser beam gets stuck in the metal.

The joining partner made of ceramic is preferably an aluminum nitride substrate between 0.5 and 2.0 mm thick. This thickness is easily cut through by the laser beam but it still has adequate breaking strength.

The ceramic is an AlN substrate having an LED with gold-plated terminals on the top side.

In one embodiment, a YAG laser is used to create the laser beam.

Each of the two joining partners may be made of a ceramic, which may be either the same or identical.

This method is preferred for joining LEDs to bases made of ceramic or joining LED circuits to a housing made of metal.

A connection between planar or partially planar thin structures of ceramics and metals such as AlN and Al is thus created with the method according to the invention, this connection being induced thermally by short laser pulses in a defined atmosphere of stagnant air, flowing air or flowing nitrogen. The laser beam passes completely through one of the joining partners (preferably the one made of ceramic) and gets stuck in the other joining partner (ceramic or metal).

This method is of interest in particular for joining small-area joining parts, e.g., for joining LEDs to bases, for inserting LED circuits into housings.

### EXAMPLES

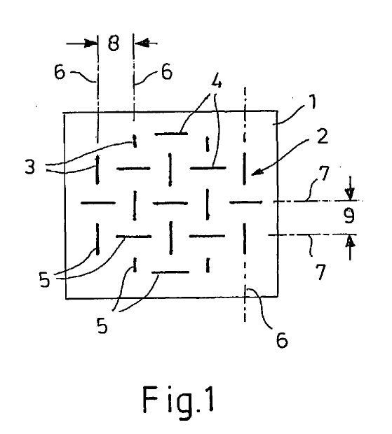

a) A planar aluminum sheet 0.7 mm thick with dimensions of 12×18 mm is placed on a slightly larger planar AlN substrate 0.63 mm thick and a YAG laser, both with and without reactive gas (in open air without any additional reaction gas) is aimed perpendicularly at the AlN substrate. The AlN substrate has an LED on top together with gold-plated terminals. A pattern (see FIG. 1) of small slots 3 mm long is cut into the ceramic down to the aluminum sheet. After being cut with a laser, the slots are filled with Al-Al₂O₃-AlN, such that the Al and AlN adhere to one another. The separating force is 50 N.

b) Same as above, except that the AlN substrate is 1.5 mm thick. A directed air stream is used here as the reactive gas.

The present invention will now be explained in greater detail with reference to FIG. 1.

FIG. 1 shows a view from above of a joining partner 1 made of ceramic, i.e., a view of the joining partner to which the laser beam is aimed. The second joining partner (not shown here) is arranged directly beneath the joining partner 1 made of ceramic.

According to the invention, a pattern 2 of individual slots is cut by the laser beam in the joining partner, with all the slots 5 forming either longitudinal slots 3 or transverse slots 4 running perpendicular to the longitudinal slots 3.

In the embodiment shown here, a transverse slot 4 has been cut or formed in proximity to a longitudinal slot 3 in each case.

All the longitudinal slots 3 are situated at a fixed distance 8 from one another on parallel longitudinal rows 6, and all the transverse slots 4 are formed on transverse rows 7 running parallel to one another at a fixed distance 9 from one another, with one longitudinal slot 3 being formed adjacent to each transverse slot 4. The distances 8 and 9 are preferably the same.

Other patterns which distribute the slots as uniformly as possible over the area are also possible.

1-15. (canceled)

16. A method of joining two joining partners at joining sites comprising the steps of:
arranging the joining partners to contact one another at the joining sites; and
directing a laser beam at one of the joining partners at the joining sites;
wherein the laser beam passes through this joining partner and penetrates at least partially into the other joining partner; and
wherein one joining partner is made of a ceramic and the other joining partner is made of a metal or a ceramic.

17. The method according to claim 16, wherein the laser beam is directed at the ceramic.

18. The method according to claim 16, wherein a slot is formed by the laser beam.

19. The method according to claim 16, wherein a pattern of individual slots is formed by the laser beam in the joining partner, such that all the slots form either longitudinal slots or transverse slots running perpendicular to the longitudinal slots.

20. The method according to claim 19, wherein a transverse slot is formed adjacent to each longitudinal slot.

21. The method according to claim 19, wherein all the longitudinal slots are arranged in longitudinal rows running parallel to one another at a fixed distance from one another, and all the transverse slots are arranged in transverse rows running parallel to one another at a fixed distance from one another, and a longitudinal slot is formed adjacent to each transverse slot.

22. The method according to any claim 16, wherein the joining partner is made of aluminum nitride ceramic and the other joining partner is made of aluminum metal.

23. The method according to any claim 16, wherein the two joining partners are made of a ceramic, which is either the same or different.

24. The method according to claim 16, wherein the laser beam is deflected onto the one joining partner in an atmosphere of stagnant air, flowing air or flowing nitrogen.

25. The method according to claim 16, wherein flat sheets are used for both joining partners.

26. The method according to claim 25, wherein the joining partner made of metal is between 0.5 and 3.0 mm thick.

27. The method according to claim 25, wherein the joining partner made of ceramic is an aluminum nitride substrate with a thickness between 0.5 and 2.0 mm.

28. The method according to claim 16, wherein the ceramic is an AlN substrate and has an LED with gold-plated terminals on the top side.

29. The method according to claim 16, the laser is a YAG laser.

30. The method according to claim 16, wherein one component comprises metal and is an LED and wherein the other joining partner is ceramic.

31. The method according to claim 16, wherein one joining partner is an LED and the other is a metal base to which eh LED is joined.
